(19) United States
(12) Patent Application Publication
(10) Pub. No.: US 2026/0176089 A1
(43) Pub. Date: Jun. 25, 2026

(54) FLOW GATED PROCESS LINE

(71) Applicant: Kevin Beauchamp, Peace Valley, MO (US)

(72) Inventor: Kevin Beauchamp, Peace Valley, MO (US)

(21) Appl. No.: 19/426,616

(22) Filed: Dec. 19, 2025

Related U.S. Application Data
(60) Provisional application No. 63/736,925, filed on Dec. 20, 2024.

(51) Int. Cl. B65G 49/04

(52) U.S. Cl. CPC B65G 49/0422; B65G 2207/00

(57) ABSTRACT

A processing assembly includes one or more treatment sections that form a treatment zone to treat parts with treatment liquid and at least one gate section couplable to one or both of a first end and a second end of the treatment zone. A frame supports the processing assembly over or within one or more tanks. The frame is sealing coupled to a cradle that defines the treatment zone. A processing auger extends within the at least one gate section and is sealing coupled within the at least one gate section to a shaft extending therethrough and to a gate section drum wall. The shaft extending through the at least one gate section defines a maximum level of treatment liquid in the treatment zone. The at least one gate section is configured to prevent treatment liquid below the maximum level of liquid from flowing from the treatment zone.

### CROSS-REFERENCE TO RELATED APPLICATIONS

This application claims the benefit of U.S. Provisional Patent Application No. 63/736,925, filed Dec. 20, 2024, the disclosure of which is hereby incorporated herein in its entirety by reference.

### BACKGROUND OF THE INVENTION

### Field of the Invention

This disclosure relates generally to an assembly for processing parts. More specifically, this disclosure relates to a module for processing parts that includes a drum having a helical auger extending therethrough.

### Background

Processing a large number of parts, including depositing a material on parts for an electroplating process, generally utilizes one or more drums for containing parts and submerging the parts in a treatment liquid. Processes may require various steps, including cleaning, treating, and rinsing that each require different solutions, and each step requires a drum that is configured to contain the parts therein for a selected period of time. In a prior art assembly, a perforated drum for containing the parts being processed is used, and processing of the parts generally includes submersing the drum containing the parts into a series of tanks containing different treatment liquids, requiring a hoist or crane to move the drum between the tanks resulting in contaminated treatment liquids. Alternatively, parts are advanced through a series of submersed drums in tanks containing different treatment liquids. In this alternative, the drums are formed to contain the parts therein for the selected time, such as by having a selected length or oscillating for a specified time, and the drums utilize augers, elevators, and/or transfer mechanisms to advance the parts within the drums and between the drums.

Efficient solutions are needed for processing parts that can be adapted to accommodate a variety of different processes having one or more process steps.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The embodiments described herein relate to a gate configured to be couplable to a treatment assembly including one or more treatment sections through which parts are advanced, the treatment assembly configured to advance parts through the one or more treatment sections submersed in a treatment liquid in a treatment zone, the gate having a diameter that is approximately equal to a diameter of the one or more treatment sections, and the gate having a longitudinal axis that when coupled to the one or more treatment sections is in alignment with a longitudinal axis of the one or more treatment sections, the gate including: a drum wall impermeable to the treatment liquid; a shaft extending within the gate and defining a maximum level of treatment liquid; and a processing auger extending within the gate and sealingly coupled to the drum wall and the shaft and defining a path of advancement for parts, wherein the processing auger includes at least two flights.

The embodiments described herein relate to a gate, wherein the gate is couplable to a first end of the one or more treatment sections, and the processing auger is rotatable in a first direction to advance parts in a forward direction while forming a barrier to prevent treatment liquid in the treatment zone from flowing therethrough.

The embodiments described herein relate to a gate, wherein the maximum level of treatment liquid defines a level at or below which treatment liquid is contained in the treatment zone and prevented from flowing through the gate.

The embodiments described herein relate to a gate, wherein the gate is couplable to a second end of the one or more treatment sections, and the gate includes a drainage section through which treatment liquid is advanced away from the path of advancement.

The embodiments described herein relate to a gate, further including a drainage section of the drum wall that includes perforations, and the drainage section is configured to drain treatment liquid away from the path of advancement.

The embodiments described herein relate to a gate, wherein the gate is configured to be supported over or within a tank, and treatment liquid above the maximum level of treatment liquid is drained into the tank.

The embodiments described herein relate to a processing assembly for processing parts, the processing assembly including: a processing auger that forms a path of advancement for parts, the processing auger including a plurality of flights; a drum wall extending around the processing auger, the drum wall including: an ingress section that is non-perforated, wherein at least two flights of the processing auger extend through the ingress section and are sealingly coupled to the drum wall, a medial section that is perforated and that defines a treatment zone of the processing assembly, and an egress section; and a cradle that extends at least under the medial section from an entry end to an exit end thereof and is configured to contain treatment liquid within the treatment zone.

The embodiments described herein relate to a processing assembly, further including a shaft extending longitudinally through the ingress section, the shaft sealingly coupled to the at least two flights of the processing auger extending therethrough and the shaft defining a maximum level of treatment liquid within the treatment zone.

The embodiments described herein relate to a processing assembly, wherein the processing assembly is configured to be supported over or within one or more tanks, and treatment liquid above the maximum level is drained into the one or more tanks.

The embodiments described herein relate to a processing assembly, wherein treatment liquid in the one or more tanks is advanced into the treatment zone.

The embodiments described herein relate to a processing assembly, wherein the cradle extends at least up to a level approximately equivalent to the maximum level.

The embodiments described herein relate to a processing assembly, wherein the drum wall further includes at least one drainage section that is perforated and extending at least after the egress section and is configured to drain treatment liquid away from the path of advancement.

The embodiments described herein relate to a processing assembly, wherein the drum wall of the egress section is non-perforated and formed with at least two flights extending therethrough.

The embodiments described herein relate to a processing assembly for processing parts, the processing assembly including: a treatment assembly including one or more treatment sections, the treatment assembly configured for treating parts in a treatment liquid; at least one gate section couplable to the treatment assembly and including a gate section drum wall and a gate section auger extending through the gate section drum wall wherein the gate section auger is coupled to the gate section drum wall and sealingly coupled to a shaft extending therethrough; wherein, an upper extent of the shaft defines a maximum level of treatment liquid in the treatment assembly, the gate section auger in the at least one gate section forms a barrier to treatment liquid in the one or more treatment sections that prevents treatment liquid from flowing outward from the treatment assembly and past the at least one gate section, and the processing assembly is rotatable in a first direction to advance parts through a path of advancement.

The embodiments described herein relate to a processing assembly, wherein each of the one or more treatment sections includes a treatment section drum wall and a treatment section auger extending through and coupled to the treatment section drum wall.

The embodiments described herein relate to a processing assembly, wherein the treatment assembly and the at least one gate section are supported over or within one or more tanks, and treatment liquid that rises over the maximum level of treatment liquid in the treatment assembly is drained into the one or more tanks.

The embodiments described herein relate to a processing assembly, wherein a treatment zone of the treatment assembly is defined by a cradle extending under the one or more treatment sections and up to a level at least as high as the maximum level of treatment liquid in the treatment assembly.

The embodiments described herein relate to a processing assembly, wherein the gate section auger of the at least one gate section includes at least one flight surrounding the shaft which prevents treatment liquid in the treatment assembly that is at or below the upper extent of the shaft from flowing outward from the treatment assembly and past the at least one flight. The embodiments described herein relate to a processing assembly, further including at least one drainage section coupled to the processing assembly downstream of the treatment assembly for draining treatment liquid away from parts advancing through the path of advancement.

The embodiments described herein relate to a processing assembly, wherein the at least one gate section is couplable to one or both of a first end and a second end of the treatment assembly.

The embodiments described herein relate to a processing assembly, wherein the one or more treatment sections have a diameter that is approximately equivalent to a diameter of the at least one gate section.

### BRIEF DESCRIPTION OF THE DRAWINGS

Embodiments of the invention are described in detail below with reference to the attached drawing figures, wherein:

FIG. 1 is a front perspective view of an embodiment of a processing system supported over a tank that includes a treatment zone, an entry gate section coupled to an entry end of the treatment zone, and an exit gate section coupled to an exit end of the treatment zone;

FIG. 2 is a perspective view of an alternate embodiment of a processing system, the view including multiple processing systems positioned in series, and each of the processing systems supported over a tank;

FIG. 3 is a plan view of the processing system shown in FIG. 1, with a screen removed from a first treatment section to show a treatment flight section;

FIG. 4 is a perspective view of a portion of the gate section shown in FIG. 1, and includes a flighting of the gate section that is sealingly coupled to a shaft extending through the gate section and a drum wall that is a solid barrier; and

FIG. 5 is a front elevation view of the processing system shown in FIG. 1, with drum walls removed from the entry gate section that includes a drainage section.

The drawing figures do not limit the invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

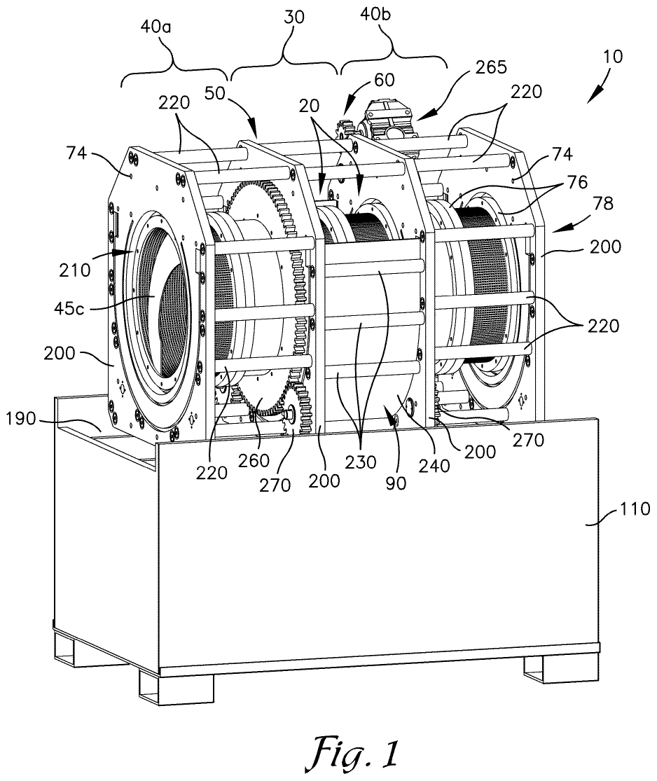

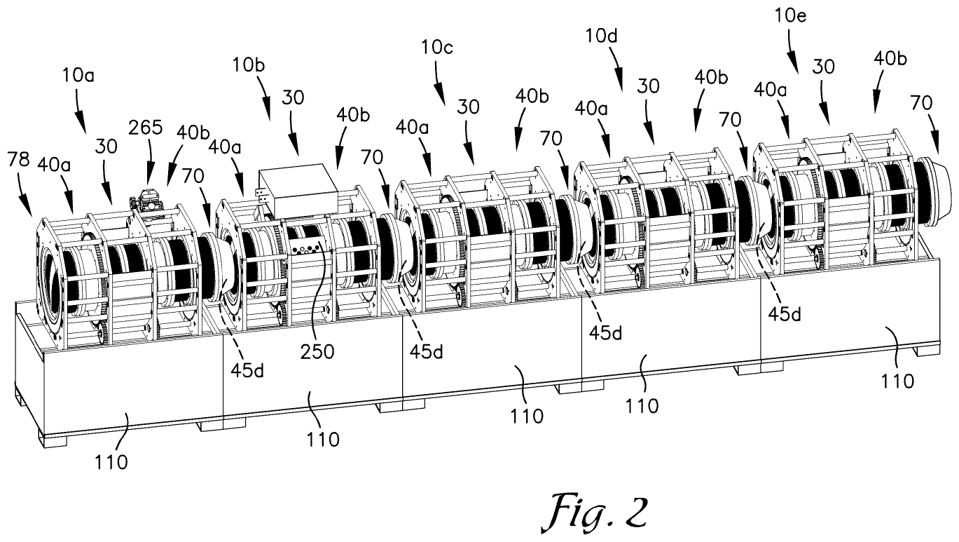

In an embodiment shown in FIG. 1, a processing system or processing assembly or flow gated processing line 10 includes a plurality of sections or modules that are combinable to accommodate a variety of different processes having one or more process steps. The plurality of sections of the processing system 10 includes one or more treatment sections 20 that are part of a treatment or flooding zone 30 and at least one gate section 40a and/or 40b coupled to at least one of the ends of the flooding zone 30. Each processing assembly 10 is associated with a process step of a process for treating parts, and the process may include one or more processing or treatment steps. In an embodiment shown in FIG. 2, multiple processing assemblies 10a-10e are coupled together in series to advance parts through multiple processing steps, including, for example, a first step in a first processing assembly 10a, a second step in a second processing assembly 10b that may be an electroplating step, a third step in a third processing assembly 10c, a fourth step in a fourth processing assembly 10d, and a fifth step in a fifth processing assembly 10e.

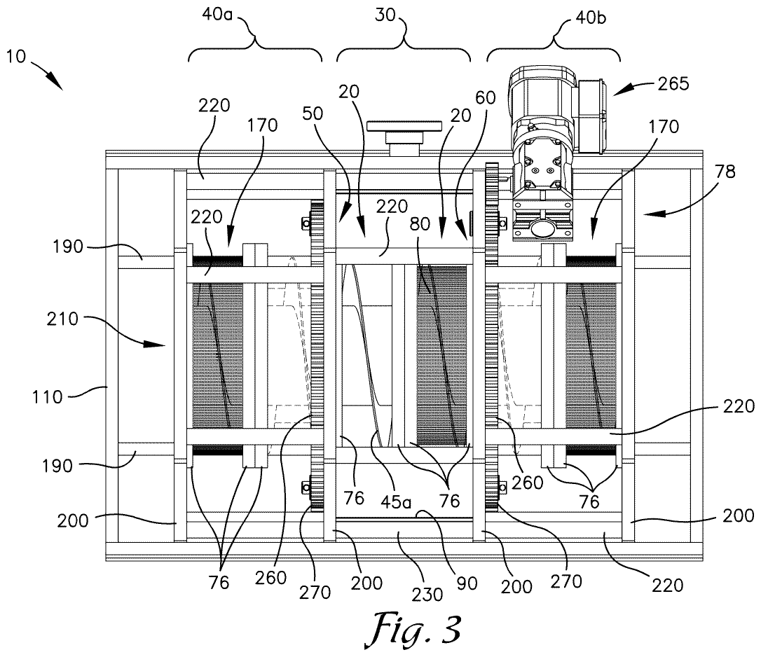

As shown in FIGS. 1 and 2, the one or more treatment sections 20 and the at least one gate section 40a and/or 40b are formed from similar drums having a similar diameter. This is best shown in FIG. 3, which is a plan view of the processing assembly 10 shown in FIG. 1. The sections 20 and 40a and/or 40b are couplable together to form a continuous path of advancement for parts along an axis parallel to a longitudinal axis of the processing assembly 10. In an embodiment, the parts are advanceable from an upstream location to a downstream location through the processing assembly 10 by a continuous auger or helical flighting that extends therethrough and forms the continuous path of advancement. The continuous helical flighting is formed from a plurality of flight sections 45 extending through each of drum of the processing assembly 10, and, in an embodiment, each flight section extends at least approximately 360° around an inner surface of a drum wall. The parts are not required to be lifted by an elevator or a plate or a transfer mechanism to advance through the processing assembly 10 between the sections 20 and/or 40 or from the first processing assembly 10a to the second processing assembly 10b, but it is contemplated that such components could be used. It is foreseeable that the sections 20 and 40 could be formed from a cylindrical drum or a drum having a multi-faceted shape.

In an embodiment, each processing assembly 10 is a modular system in which one or more treatment sections 20 are configurable for treating parts for a selected time that is directly proportional to a length of the flooding zone 30 or directly proportional to a number of treatment sections 20 in the flooding zone 30. The one or more treatment sections 20 are couplable to form the processing assembly 10 that is configured to accommodate a step of a process depending on requirements of the process. In an embodiment, one or more additional treatment sections 20 may be added to lengthen or change a time that the parts are treated in the processing assembly 10. Conversely, in an embodiment one or more treatment sections 20 may be eliminated to shorten or change a time that parts are treated in the processing assembly 10. The one or more treatment sections 20 may be collectively referred to as a treatment assembly. The time that parts are treated also depends on other factors understood by one skilled in the art, including, for example, a speed at which the processing assembly 10 rotates, a number and a size of the parts being processed, a composition of the parts and/or treatment liquid, a number of flights that form each of the flight sections 45, and a rate at which the treatment liquid is circulated through the parts.

The processing assembly 10 includes at least one gate section 40a and/or 40b that may be coupled to one or both of a first or entry end 50 and a second or exit end 60 of the flooding zone 30, depending on requirements of the process. In an embodiment, an ingress section or first gate section 40a is coupled to the entry end 50 of the flooding zone 30 to prevent the treatment liquid from flowing upstream and to maintain the treatment liquid within the flooding zone 30 at or below a maximum level of liquid, as described herein. In an embodiment, an egress section or second gate section 40b is coupled to the exit end 60. Preferably, the first gate section 40a is coupled to the entry end 50 and the second gate section 40b is coupled to the exit end 60.

As an example of the modularity of the processing assembly 10, in FIG. 1 the processing assembly 10 includes two treatment sections 20 and the ingress and egress gate sections 40a and 40b coupled to each of the ends 50 and 60, respectively, of the flooding zone 30. In the embodiment shown in FIG. 2 the processing assemblies 10a-10e each include a transition sections 70 through which parts transition from a first processing assembly 10 to a subsequent, adjacent second processing assembly 10 or exit the processing assembly 10. It is foreseeable that the processing assembly 10 could be formed to include one or more of: one or more drums that each include a drum wall extending therearound, each drum wall having one or more perforated sections and/or one or more non-perforated sections, the first gate section 40a, the second gate section 40b, and/or other components, as described herein.

The sections 20 and 40 of the processing assembly 10 may be coupled together with a plurality of ties rods (not shown). The tie rods may extend through apertures 74 (see FIG. 1) formed in a frame 78 that supports the processing assembly 10 or formed in mounts or coupling members or sealing elements 76 positioned on ends of the drums or the sections 20, 30, and/or 40 and that are secured to the frame 78. The tie rods may pull the drums or sections 20, 30 and/or 40 together to reinforce a sealing relationship therebetween. In an embodiment, a coupling member 76 is couplable to a coupling member 76 of an adjacent drum or an adjacent section 20, 30, or 40 to sealingly couple the drums or the sections 20, 30, and/or 40 together or the sections 20, 30, and/or 40 may share a coupling member 76 that extends therebetween. In an embodiment, a coupling member 76 of a section 20, 30, and/or 40 is sealingly couplable to and supported in a frame 78. The tie rods maintain alignment of the sections 20, 30 and/or 40 and provide stability to the processing assembly 10. In an embodiment, the tie rods are configured to reinforce a sealing relationship of the adjacent drums or adjacent sections 20, 30 and/or 40 or a sealing relationship between the sections 20, 30 and/or 40 and the frame 78.

The flooding zone 30 is configured to contain the treatment liquid to treat parts advancing through the processing assembly 10. As best shown in FIG. 3, the flooding zone 30 comprises one or more treatment sections 20 that each includes a permeable wall or screen 80 that forms an outer drum wall thereof. The screen 80 includes openings formed therein such that the treatment liquid is able to circulate into and out of the treatment section 20 and around parts advancing therethrough while the parts are contained in the path of advancement. The flooding zone 30 is defined by and supported over a cradle 90 sealingly coupled to the frame 78, and the cradle 90 contains the treatment liquid within the flooding zone 30 such that the treatment liquid floods or is circulated through the screen 80 of the one or more treatment sections 20. In an embodiment, the cradle 90 is spaced a distance from the one or more sections 20 to enable efficient circulation of the treatment liquid. In an embodiment, the cradle 90 curves around and is adjacent to the one or more sections 20 to minimize treatment liquid used in the process. In an embodiment, the treatment liquid submerges the parts being advanced through the processing assembly 10 to treat the parts. It is foreseeable that one or more of the treatment sections 20 may comprise a solid barrier wall depending on requirements of the process step.

As shown in FIG. 3, the one or more treatment sections 20 may each comprise a treatment flight section or processing auger 45a that forms a portion of the continuous helical flighting of the processing assembly 10. Each treatment flight section 45a is coupled to or secured adjacent an inner surface of the screen 80 of the associated treatment section 20 and positioned such that the parts are advanceable through the path of advancement formed by the flighting 45a and are unable to slide between the screen 80 and the treatment flight section 45a. When the one or more treatment sections 20 are coupled together, the one or more treatment flight sections 45a are configured to form the continuous helical flighting that extends within the treatment zone 30. In an embodiment, a shaft (not shown) extends longitudinally through each treatment section 20, and each treatment flight section 45a may be coupled to the shaft.

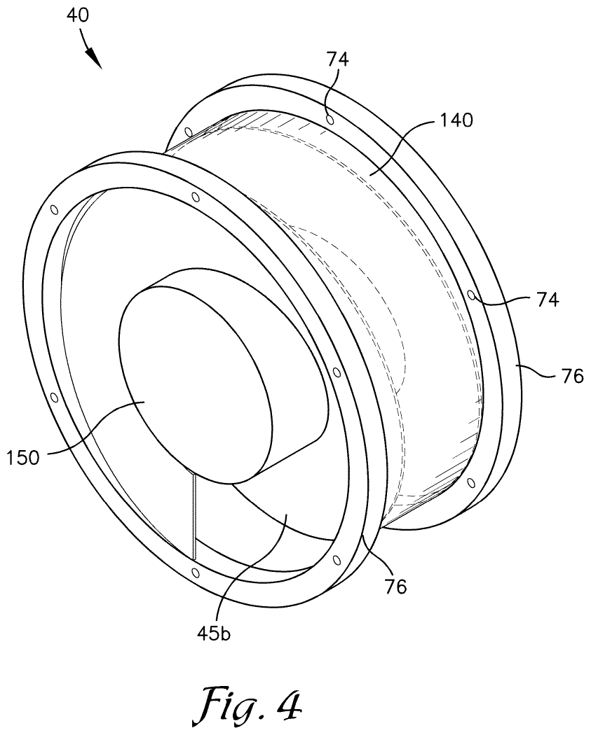

FIG. 4 shows an embodiment of the gate section or gate 40, which may form one or both of gate sections 40a and 40b, that includes a drum wall 140, a shaft 150 that extends through a central longitudinal axis of the gate section 40, and a gate flight section or processing auger 45b that extends between and is sealingly coupled to the drum wall 140 and to the shaft 150. The drum wall 140 of the gate section 40 forms a solid barrier that is non-perforated or impermeable to the treatment liquid. The shaft 150 is formed integrally with or sealingly coupled to the gate flight section 45b. In an embodiment, the gate flight section 45b of the first gate section 40a coupled to the entry end 50 comprises at least one flight, and preferably at least two flights to contain the treatment liquid in the flooding zone 30 as described herein. In an embodiment, the second gate section 40b coupled to the exit end 60 of the flooding zone 30 is formed similarly to the gate section 40a at the entry end 50 and is interchangeable therewith. When the gate section 40 is coupled to the flooding zone 30, the gate flight section 45b extending within the gate section 40 forms the continuous helical flighting of the processing assembly 10 with the one or more treatment flight sections 45a of the treatment sections 20.

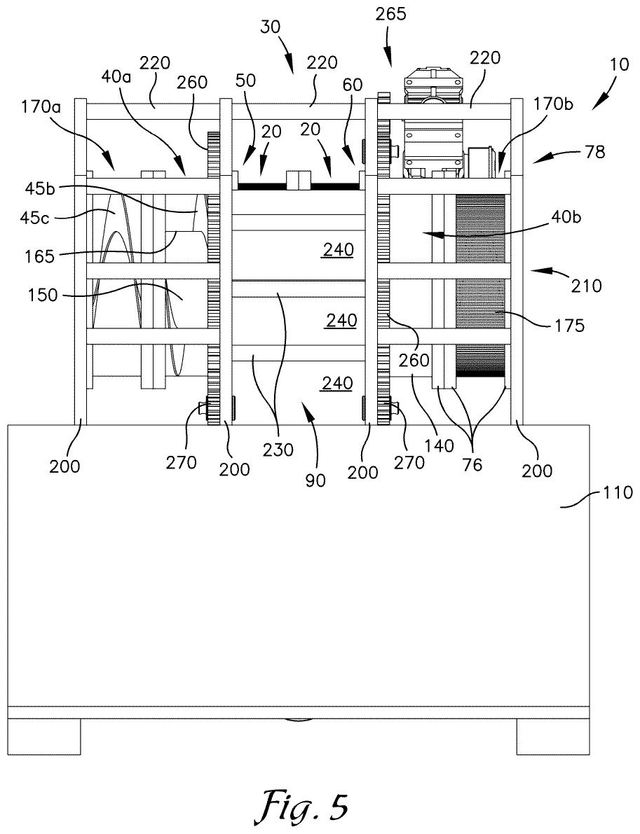

In an embodiment, the gate section 40a coupled to the entry end 50 prevents the treatment liquid from flowing upstream when the treatment liquid is maintained within the flooding zone 30 below a maximum level of liquid 165, which is best shown in FIG. 5. The shaft 150 and the gate flight section 45b form a plug or barrier that prevents the treatment liquid below the maximum level of liquid 165 from flowing upstream or outward from the one or more treatment sections 20 or treatment assembly and past the gate section 40a. The shaft 150 defines the maximum level of liquid 165 that the processing assembly 10 is able to contain within the flooding zone 30. In an embodiment, the maximum level of liquid 165 is at or below a horizontal plane that corresponds to a top or an upper extent of the shaft 150. When the treatment liquid is maintained at least just below the maximum level of liquid 165, the treatment liquid is unable to pass upstream of the gate section 40a, even as the parts are advanced therethrough from an upstream location to a downstream location. If the treatment liquid level rises above or over the maximum level of liquid 165, excess treatment liquid above the maximum level of liquid 165 is able to flow over the shaft 150 and in an upstream direction. The processing assembly 10 may comprise a liquid level sensor (not shown) to control a pump (not shown) that pumps treatment liquid into the flooding zone 30 to maximize the amount of treatment liquid for submersing the parts, while maintaining a level of treatment liquid below the maximum level of liquid 165.

As shown in FIG. 3, the gate sections 40 may include or be positioned adjacent a drainage section 170 through which treatment liquid therein is drained into one or more tanks 110. It is foreseeable that a gate section 40 may not include a drainage section 170. It is also foreseeable that a gate section 40 may be a drainage section 170 that does not include a drum wall that forms a solid barrier. The drainage section 170 includes openings formed in a drum wall 175 thereof and a drainage flight section or processing auger 45c that forms part of the continuous helical flighting when the gate section 40 is coupled to the flooding zone 30. At least a portion of the drum wall 175 is a screen or grate. The drainage flight section 45c is formed integrally with or positioned adjacent the drum wall 175 such that parts are not able to slide between the drainage flight section 45c and the drum wall 175. The drainage flight section 45c advances parts through a portion of the path of advancement that is within the drainage section 170. The drainage section 170 is configured to maintain the parts advancing through the drainage section 170 within the path of advancement and allow liquid to drain into the one or more tanks 110. The drainage section 170 functions to recycle the treatment liquid, to prevent contamination of a treatment liquid in a subsequent process step, and/or to remove the liquid from the parts. In an embodiment shown in FIG. 5, the drainage section 170b positioned downstream of the second gate section 40b that is coupled to the processing assembly 10 downstream of the treatment assembly or coupled to the exit end 60 of the flooding zone 30 removes or drains the treatment liquid through the openings of the drainage section 170b and into the tank 110 prior to advancing the parts out of the processing assembly 10. The treatment liquid is able to drain away from the parts advancing therethrough and prevent the treatment liquid from flowing downstream. In an embodiment, the drainage section 170a positioned upstream of the gate section 40a that is coupled to the entry end 50 of the flooding zone 30 removes or drains liquid through the openings of the drainage section 170a and into the tank 110 such that liquid advanced into the processing assembly 10 with the parts is drained away prior to advancing into the treatment zone 30. Further, excess treatment liquid beyond the maximum level of liquid 165 in the flooding zone 30 that flows over the shaft 150 may flow into the drainage section 170a and be drained into the tank 110.

One or more pumps (not shown) may pump or recycle the treatment liquid in the tank 110 to the flooding zone 30 to treat parts. In an embodiment, the processing assembly 10 may be supported over multiple tanks or over a divided tank. In an embodiment that includes a drainage section 170a positioned prior to the flooding zone 30, liquid from the drainage section 170a drained into the tank 110 or a into a first tank may not be recycled to the flooding zone 30 to avoid contaminating the treatment liquid contained therein. In an embodiment that includes a drainage section 170b positioned after the flooding zone 30, treatment liquid from the drainage section 170b drained into the tank 110 or a second tank may be recycled into the flooding zone 30 for use.

FIG. 2 shows an embodiment of the processing assembly 10 that includes transition sections 70 coupled and secured to the gate sections 40b at the exit ends 60 of the flooding zones 30 in the processing assemblies 10a-10e. The transition sections 70 transition or advance parts from a previous processing assembly 10 to a subsequent processing assembly 10 and out of a terminal processing assembly 10 at the end of the processing assembly 10. In an embodiment, each of the transition sections 70 is formed in a frustoconical shape such that a diameter of the transition section 70 narrows from the gate section 40 of the processing assembly to which it is secured, outward or toward the subsequent processing assembly 10 to advance parts therein. The transition section 70 is configured such that treatment liquid advancing with the parts is able to drain, via gravity, in an upstream direction toward the drainage section 170b. In an embodiment, the transition section 70 of the processing assembly 10 extends into an entry of the subsequent processing assembly 10 to deliver parts therein. The transition section 70 includes a transition flight section or processing auger 45d that advances parts therethrough and forms a part of the continuous helical flighting of the processing assembly 10. It is foreseeable that a first processing assembly 10 could feed directly into a second processing assembly 10 without a transition section 70 or that the transition section 70 could be formed having a cylindrical shape.

In an embodiment, the frame 78 supports the one or more treatment sections 20 and/or the gate sections 40 of the processing assembly 10 above and/or within the one or more tanks 110, which may include support brackets 190 therein for further supporting the processing assembly 10 thereabove or therein (see FIG. 3). The frame 78 includes a plurality of support walls 200 formed similarly, and each support wall 200 includes an aperture or bore 210 formed therein through which the parts are advanced along the continuous helical flighting. The support walls 200 are positioned at an entry and/or an exit of each the sections 20, 30, and/or 40 to support the processing assembly 10. The frame 78 may include a first support wall 200 coupled to the entry end 50 of the flooding zone 30, a second support wall 200 coupled to the exit end 60 of the flooding zone 30, and one or more intermediate support walls (not shown) that support the treatment sections 20 between the ends 50 and 60. Each of the support walls 200 includes the aperture 210 formed therein. In an embodiment, one or more of the intermediate support walls may be positioned between the treatment sections 20 such that each of the sections 20 is sealingly coupled to the support walls adjacent to or within the respective aperture 210, or one or more of the intermediate support walls may be positioned corresponding to the coupling members 76 of the adjacent treatment sections 20 that are sealing coupled together and are configured to be supported within the aperture 210 extending through an intermediate support wall.

The plurality of support walls 200 are reinforced by a plurality of support braces or ties 220 that extend between or through the support walls 200. The plurality of support walls 200 may have an irregular hexagonal shape, and the support braces 220 may extend adjacent to each of the corners of the hexagonal shape to support and provide structural integrity to the frame 78. It is foreseeable that the plurality of support braces 220 could be alternatively positioned relative to the plurality of support walls 200 to support the frame 78. In an embodiment, the plurality of support braces 220 extend through and support intermediate support walls to maintain a structure of the frame 78. Further, a plurality of secondary support braces 230 may extend between or through the support walls 200 and/or the intermediate support walls, similar to the plurality of support braces 220. The plurality of secondary support braces 230 may be positioned to support the cradle 90, such as, for example, adjacent to upper edges of the cradle 90 and adjacent to a lower curve of the cradle 90. In an embodiment, the secondary support braces 230 extend on the sides of the cradle 90 to support a curvature of the cradle 90 that curves around the flooding zone 30 and around the one or more treatment sections 20.

The cradle 90 may comprise one or more cradle sections or plates 240. In an embodiment, each of the one or more treatment sections 20 is associated with a cradle section 240 that is sealing coupled to and between the support walls 200 that extend at an entry and an exit of that treatment section 20. In an embodiment, a channel (not shown) may be formed on a lateral surface of the support walls 200 to which the cradle 90 is coupled to sealingly support the cradle 90 therein. In an embodiment, each cradle section 240 is formed from a polymer substrate that is curved or bent around the associated treatment section 20. As shown in FIG. 2, one or more of the cradle sections 240 may include a containment section 250 that may be configured to contain the plating material for an electroplating process. In an embodiment, the one or more cradle sections 240 may include a handle for a user to grasp. The cradle 90 comprising the one or more cradle sections 240 has a length of approximately the same length as the flooding zone 30 to contain the treatment liquid therein. In an embodiment, the cradle 90 extends upward on both sides of the flooding zone 30 such that the treatment liquid that is at or below the maximum level of liquid 165 is able to be contained therein, that is, the cradle 90 extends at least as high as the horizontal plane that corresponds to the top of the shaft 150 to contain the treatment liquid therein. In an embodiment, the cradle 90 is formed from a plate 240 that curves around the flooding zone 30.

The processing assembly 10 includes at least one means of rotating the processing assembly 10 that includes a drive gear assembly. The drive gear assembly includes at least one drive gear 260 secured to a drum and extending therearound to rotate the processing assembly 10. In an embodiment, a drive gear 260 is positioned on each side of the flooding zone 30, with the cradle 90 extending therebetween. At least one drive gear 260 of the processing assembly 10 is engaged and driven by a motor and drive gear assembly 265 to rotate the processing assembly 10. It is foreseeably that a motor and drive gear assembly 265 may drive a plurality of processing assemblies 10. The drive gear 260 may be supported by one or more idler gears 270 that support and engage the drive gear 260. In an embodiment, a drive gear 260 is positioned adjacent to the support wall 200 at the entry end 50 of the flooding zone 30 opposite the cradle 90. In an embodiment, a drive gear 260 is positioned adjacent the support wall 200 at the exit end 60 of the flooding zone 30 opposite the cradle 90. The means for rotating the processing assembly rotates the processing assembly 10 in a first direction to advance the parts therein. It is foreseeable that the means for rotating the processing assembly could rotate the processing assembly 10 in a second direction.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

What is claimed is:

1. A gate configured to be couplable to a treatment assembly comprising one or more treatment sections through which parts are advanced, the treatment assembly configured to advance parts through the one or more treatment sections submersed in a treatment liquid in a treatment zone, the gate having a diameter that is approximately equal to a diameter of the one or more treatment sections, and the gate having a longitudinal axis that when coupled to the one or more treatment sections is in alignment with a longitudinal axis of the one or more treatment sections, the gate comprising:
a drum wall impermeable to the treatment liquid;
a shaft extending within the gate and defining a maximum level of treatment liquid; and
a processing auger extending within the gate and sealingly coupled to the drum wall and the shaft and defining a path of advancement for parts, wherein the processing auger includes at least two flights.

2. The gate of claim 1, wherein the gate is couplable to a first end of the one or more treatment sections, and the processing auger is rotatable in a first direction to advance parts in a forward direction while forming a barrier to prevent treatment liquid in the treatment zone from flowing therethrough.

3. The gate of claim 1, wherein the maximum level of treatment liquid defines a level at or below which treatment liquid is contained in the treatment zone and prevented from flowing through the gate.

4. The gate of claim 1, wherein the gate is couplable to a second end of the one or more treatment sections, and the gate includes a drainage section through which treatment liquid is advanced away from the path of advancement.

5. The gate of claim 1, further comprising a drainage section of the drum wall that includes perforations, and the drainage section is configured to drain treatment liquid away from the path of advancement.

6. The gate of claim 1, wherein the gate is configured to be supported over or within a tank, and treatment liquid above the maximum level of treatment liquid is drained into the tank.

7. A processing assembly for processing parts, the processing assembly comprising:
a processing auger that forms a path of advancement for parts, the processing auger including a plurality of flights;
a drum wall extending around the processing auger, the drum wall including:
an ingress section that is non-perforated, wherein at least two flights of the processing auger extend through the ingress section and are sealingly coupled to the drum wall,
a medial section that is perforated and that defines a treatment zone of the processing assembly, and
an egress section; and
a cradle that extends at least under the medial section from an entry end to an exit end thereof and is configured to contain treatment liquid within the treatment zone.

8. The processing assembly of claim 7, further comprising a shaft extending longitudinally through the ingress section, the shaft sealingly coupled to the at least two flights of the processing auger extending therethrough and the shaft defining a maximum level of treatment liquid within the treatment zone.

9. The processing assembly of claim 8, wherein the processing assembly is configured to be supported over or within one or more tanks, and treatment liquid above the maximum level is drained into the one or more tanks.

10. The processing assembly of claim 9, wherein treatment liquid in the one or more tanks is advanced into the treatment zone.

11. The processing assembly of claim 8, wherein the cradle extends at least up to a level approximately equivalent to the maximum level.

12. The processing assembly of claim 7, wherein the drum wall further comprises at least one drainage section that is perforated and extending at least after the egress section and is configured to drain treatment liquid away from the path of advancement.

13. The processing assembly of claim 7, wherein the drum wall of the egress section is non-perforated and formed with at least two flights extending therethrough.

14. A processing assembly for processing parts, the processing assembly comprising:
a treatment assembly comprising one or more treatment sections, the treatment assembly configured for treating parts in a treatment liquid;
at least one gate section couplable to the treatment assembly and including a gate section drum wall and a gate section auger extending through the gate section drum wall wherein the gate section auger is coupled to the gate section drum wall and sealingly coupled to a shaft extending therethrough; wherein,
an upper extent of the shaft defines a maximum level of treatment liquid in the treatment assembly,
the gate section auger in the at least one gate section forms a barrier to treatment liquid in the one or more treatment sections that prevents treatment liquid from flowing outward from the treatment assembly and past the at least one gate section, and
the processing assembly is rotatable in a first direction to advance parts through a path of advancement.

15. The processing assembly of claim 14, wherein each of the one or more treatment sections comprises a treatment section drum wall and a treatment section auger extending through and coupled to the treatment section drum wall.

16. The processing assembly of claim 14, wherein the treatment assembly and the at least one gate section are supported over or within one or more tanks, and treatment liquid that rises over the maximum level of treatment liquid in the treatment assembly is drained into the one or more tanks.

17. The processing assembly of claim 14, wherein a treatment zone of the treatment assembly is defined by a cradle extending under the one or more treatment sections and up to a level at least as high as the maximum level of treatment liquid in the treatment assembly.

18. The processing assembly of claim 14, wherein the gate section auger of the at least one gate section comprises at least one flight surrounding the shaft which prevents treatment liquid in the treatment assembly that is at or below the upper extent of the shaft from flowing outward from the treatment assembly and past the at least one flight.

19. The processing assembly of claim 14, further comprising at least one drainage section coupled to the processing assembly downstream of the treatment assembly for draining treatment liquid away from parts advancing through the path of advancement.

20. The processing assembly of claim 14, wherein the at least one gate section is couplable to one or both of a first end and a second end of the treatment assembly.

21. The processing assembly of claim 14, wherein the one or more treatment sections have a diameter that is approximately equivalent to a diameter of the at least one gate section.
